(19) United States
(12) Patent Application Publication
(10) Pub. No.: US 2015/0329751 A1
(43) Pub. Date: Nov. 19, 2015

(54) REACTIVE COMPOSITION COMPRISING POLYAMINES AND A DISPERSION CONTAINING URETDIONE GROUPS

(71) Applicants: Wiebke STACHE, Herten (DE); Emmanouil SPYROU, Schermbeck (DE); Iris BRÜCKNER, Dorsten (DE); Sven BÜSCHER, Ahaus (DE); Jessika SCHÜLLER, Gunderath (DE)

(72) Inventors: Wiebke STACHE, Herten (DE); Emmanouil SPYROU, Schermbeck (DE); Iris BRÜCKNER, Dorsten (DE); Sven BÜSCHER, Ahaus (DE); Jessika SCHÜLLER, Gunderath (DE)

(73) Assignee: EVONIK INDUSTRIES AG, Essen (DE)

(21) Appl. No.: 14/711,370

(22) Filed: May 13, 2015

(30) Foreign Application Priority Data
May 15, 2014 (DE) 102014209183.7

(51) Int. Cl. C09J 175/02; C08K 5/00; C08K 3/00; C09D 175/02

(52) U.S. Cl. CPC C09J 175/02; C09D 175/02; C08K 5/0008; C08K 3/0008

(57) ABSTRACT

A reactive composition contains A) an aqueous polyurethane-polyurea dispersion containing an uretdione group and having an internal emulsifier, the emulsifier having at least one ionogenic group which, in the case of an acidic ionogenic group, has a pKₐ in water of >8 at room temperature or, in the case of a basic ionogenic group, has a pK_{b} of >8 at room temperature, B) at least one diamine and/or polyamine, wherein a ratio of a latent NCO group in the polyurethane-polyurea dispersion A) containing an uretdione group to the amine groups in component B) is from 4:1 to 1:1, and C) optionally, at least one member selected from the group consisting of an auxiliary, an adjuvant and a catalyst.

### BACKGROUND OF THE INVENTION

1. Field of the Invention

The invention relates to a reactive composition consisting of an aqueous polyurethane-polyurea dispersion containing uretdione groups and having special internal emulsifiers, and diamines or polyamines, and the use thereof as a starting component in the production of polyurethane plastics, more particularly for water-soluble or water-dispersible paint, adhesive or sealant binders or binder components.

2. Discussion of the Background

Against the background of increasingly stringent environmental legislation, recent years have seen gains in significance for water-dispersible polyisocyanates for a variety of application fields. They find use nowadays in particular as crosslinker components for high-quality, water-thinable, two-component polyurethane paints (2K PUR paints) or as adjuvants for aqueous dispersion-based adhesives. They serve for crosslinking of aqueous dispersions in textile finishing or leather finishing, or of formaldehyde-free textile printing inks, and are also suitable, furthermore, for example as auxiliaries for the wet-strengthening of paper, as disclosed in EP 959 087, for example.

For the production of water-dispersible hydrophilic polyisocyanates there are a multitude of different methods known; in some of them ionic modifications are relevant. EP-A 443 138, EP-A 510 438 and EP-A 548 669 describe, for example, polyisocyanate mixtures which contain chemically bonded carboxyl groups. The stability of such hydrophilic polyisocyanates in dispersion in water is low, because the free NCO groups are consumed by reaction with water.

As well as hydrophilic polyisocyanates having free NCO groups, there are also 1K systems known that are based on externally blocked polyisocyanates. The disadvantage of these prior-art 1K systems based on externally blocked polyisocyanates is that the respective blocking agents are given off in the course of curing or baking.

PCT/EP2013/067330 describes water-dispersible, hydrophilic, uretdione-containing polyisocyanates and polyisocyanate mixtures, and the reaction thereof with a reactant that contains hydroxyl groups and is soluble or emulsifiable or dispersible in water, in the presence of auxiliaries and/or adjuvants and, optionally, of a catalyst.

This composition is a 1K system, which must be cured at an elevated temperature (30 minutes at 130° C. or 180° C.).

JP2006-321839A describes an aqueous 1K system consisting of a hydrophilic, blocked polyisocyanate containing uretdione groups and of a hydrophilic polyol, this system likewise having to be cured at elevated temperatures (10 minutes at 205° C.).

WO97/18257 describes aqueous polyurethane dispersions, the polyurethanes containing uretdione groups. Through reaction with suitable reactive polyamine compounds such as primary or secondary diamines, hydrazines or polyhydrazides, for example, a crosslinking reaction can take place.

WO2012130711 describes a latently reactive polyurethane dispersion with achievable crosslinking, which consists of an uretdione-containing polyurethane dispersion and of at least one solid polyamine with a deactivated surface. Crosslinking with the polyamine in that case take places only above its melting point.

The patent applications cited above make no statement on the keeping properties of the dispersion containing uretdione groups. Experience generally suggests that substances containing uretdione groups, when introduced into water, undergo significant reduction in their NCO content after just a few days. Thus the simplest form of hydrophilization, the attachment of polyether groups, results in a product which is not stable in water. DE-A 25 38 484, for example, describes one-component dispersions in which first of all a prepolymer is prepared from polyisocyanates and from polyesters which have hydroxyl group functionality, and this prepolymer is reacted with 30-70 equivalent % of diamines or diols, after which the product is hydrophilized and then dispersed. Employed as polyisocyanate is the uretdione of isophorone diisocyanate, optionally in mixtures with isophorone diisocyanate and its trimers, this 1K system comprising one hydroxyl group for each of the two isocyanate groups capped in the uretdione, the hydroxyl groups being added at the dispersing stage or thereafter. The hydrophilized polyisocyanate is notable for a very limited stability in water.

DE 10 2005 036654 claims polyurethane dispersions which in the same molecule have not only uretdione groups but also groups that are reactive towards isocyanate groups. As a result, as well as the crosslinking between the polyurethane molecules, there is also a possibility of crosslinking within the polymer, referred to as an “intra-penetrating network”. Even these elimination product-free, aqueous polyurethane curing agents are of only very limited stability on storage in water.

### SUMMARY OF THE INVENTION

It was an object of the present invention, therefore, to provide an aqueous composition, based on polyurethane and/or polyurea chemistry, individual components are stable on storage and which reacts, with crosslinking, at low temperatures, without exhibiting the disadvantages of the abovementioned systems.

The invention relates to a reactive composition consisting of an aqueous polyurethane-polyurea dispersion containing uretdione groups and having special internal emulsifiers, and diamines or polyamines, and the use thereof as a starting component in the production of polyurethane plastics, more particularly for water-soluble or water-dispersible paint, adhesive or sealant binders or binder components.

The above object and other objects have been achieved by the present invention the first embodiment of which includes a reactive composition, comprising:
A) an aqueous polyurethane-polyurea dispersion containing an uretdione group and comprising an internal emulsifier, the emulsifier comprising at least one ionogenic group which, in the case of an acidic ionogenic group, has a pKₐ in water of >8 at room temperature or, in the case of a basic ionogenic group, has a pK_{b} of >8 at room temperature,
B) at least one diamine, polyamine or a mixture thereof,
   wherein a ratio of a latent NCO group in the polyurethane-polyurea dispersion A) containing an uretdione group to the amine groups in component B) is from 4:1 to 1:1, and
C) optionally, at least one member selected from the group consisting of an auxiliary, an adjuvant and a catalyst.

### DETAILED DESCRIPTION OF THE INVENTION

Surprisingly it has been found that this object can be achieved by reactive compositions consisting of an aqueous polyurethane-polyurea dispersion containing uretdione groups and having specific internal emulsifiers, and diamines or polyamines.

A subject of the invention is a reactive composition substantially comprising
A) an aqueous polyurethane-polyurea dispersion containing uretdione groups and having internal emulsifiers, the emulsifier comprising at least one ionogenic group which, in the case of an acidic ionogenic group, has a pKₐ in water of >8 at room temperature or, in the case of a basic ionogenic group, has a pK_{b} of >8 at room temperature,
B) at least one diamine and/or polyamine,
the ratio of latent NCO groups in the polyurethane-polyurea dispersion A) containing uretdione groups to the amine groups in component B) being 4:1 to 1:1,
C) optionally auxiliaries and adjuvants and/or catalysts.

Also a subject of the invention is production of the reactive composition and the use of this reactive composition as a starting component in the production of polyurethane plastics, more particularly for water-soluble or water-dispersible paint, adhesive or sealant binders or binder components.

The ranges described herein include all values and subvalues between the upper and lower limits.

The method for producing the reactive compositions of the invention encompasses the preparation of an aqueous polyurethane-polyurea dispersion containing uretdione groups and having special internal emulsifiers, as described in WO2014/053269 (PCT/EP2013/067330), this dispersion also being identified below as dispersion A).

The preparation of this dispersion A) encompasses, in the first step, the preparation of the hydrophilic polyisocyanate P by reaction of a prepolymer I carrying uretdione groups with at least one emulsifier II, the emulsifier II comprising at least one ionogenic group which, in the case of an acidic ionogenic group, has a pKₐ in water of >8, preferably >10 and very preferably >12 at room temperature, or, in the case of a basic ionogenic group, has a pK_{b} of >8, preferably >10 and very preferably >12 at room temperature.

Polyisocyanates containing uretdione groups are used for preparing the prepolymer I carrying uretdione groups. Polyisocyanates containing uretdione groups are well-known and are described in, for example, U.S. Pat. No. 4,476,054, U.S. Pat. No. 4,912,210, U.S. Pat. No. 4,929,724 and also EP 417 603. A comprehensive overview of industrially relevant processes for the dimerization of isocyanates to uretdiones is provided by J. Prakt. Chem. 336 (1994) 185-200.

For the preparation of the prepolymer I carrying uretdione groups, a broad selection of polyisocyanates are suitable. Suitable polyisocyanates are preferably selected from the group consisting of isophorone diisocyanate (IPDI), hexamethylene diisocyanate (HDI), 2,2′-dicyclohexylmethane diisocyanate (2,2′-H₁₂MDI), 2,4′-dicyclohexylmethane diisocyanate (2,4′-H₁₂MDI), 4,4′-dicyclohexylmethane diisocyanate (4,4′-H₁₂MDI) and any desired mixtures of these isomers, 2-methylpentane diisocyanate (MPDI), a mixture of 2,2,4-trimethylhexamethylene diisocyanate (2,2,4-TMDI) and 2,4,4-trimethylhexamethylene diisocyanate (2,4,4-TMDI), norbornane diisocyanate (NBDI), methylenediphenyl diisocyanate (MDI), toluidine diisocyanate (TDI), tetramethylxylylene diisocyanate (TMXDI), m-xylylene diisocyanate (XDI), alone or in mixtures. In one preferred embodiment the isocyanate is IPDI and/or 4,4′-H₁₂MDI and/or HDI.

The conversion of these polyisocyanates carrying uretdione groups into prepolymers I containing uretdione groups involves the reaction of the free NCO groups with monomeric, oligomeric and/or polymeric compounds containing hydroxyl groups. The compound containing hydroxyl groups is preferably selected from the group consisting of polyesters, polythioethers, polyethers, polycaprolactams, polyepoxides, polyesteramides, polyurethanes, low molecular mass dialcohols, low molecular mass trialcohols, low molecular mass tetraalcohols and monoalcohols. Low molecular mass di-, tri- and/or tetraalcohols are suitable as chain extenders. As chain terminators, monoamines and/or monoalcohols may be used, for example as described in EP 669353, EP 669354, DE 3030572, EP 639598 or EP 803524.

Preferred for use are polyesters having a OH number of 30 to 1000 mg KOH/g and a number-average molecular weight of 300 to 6000 g/mol (Mn, determined by gel permeation chromatography) or monomeric dialcohols, such as, for example ethylene glycol, propane-1,2-diol and propane-1,3-diol, 2,2-dimethylpropane-1,3-diol, butane-1,4-diol, hexane-1,6-diol, 2-methylpentane-1,5-diol, 2,4,4-trimethylhexane-1,6-diol, 2,4,4-trimethylhexane-1,6-diol, heptane-1,7-diol, dodecane-1,12-diol, 9-octadecene-1,12-diol, thiodiglycol, octadecane-1,18-diol, 2,4-dimethyl-2-propylheptane-1,3-diol, diethylene glycol, triethylene glycol, tetraethylene glycol, trans- and cis-1,4-cyclohexanedimethanol, alone or in mixtures. Preferred monomeric dialcohols are ethylene glycol, propane-1,2-diol and propane-1,3-diol, 2,2-dimethylpropane-1,3-diol, butane-1,4-diol and/or hexane-1,6-diol.

Preferred prepolymers I containing uretdione groups have a free NCO content of at least 0.2 but not more than 20 wt %, based on the total weight of the prepolymer, and a uretdione group content of 0.5 to 25 wt %, based on the total weight of the prepolymer, preferably 2 to 20 wt % (calculated as C₂N₂O₂, molecular weight 84).

Apart from the uretdione groups, the prepolymer I may also have isocyanurate, biuret, allophanate, urethane and/or urea structures.

The emulsifier II comprises one or more ionogenic groups, preferably one ionogenic group. An ionogenic group is preferably selected from the group consisting of sulphonates and phosphates.

In one preferred embodiment the ionogenic group of the emulsifier II is a radical giving a predominantly neutral reaction in water. In the case of an acidic ionogenic group, it has a pKₐ of >8 in water at room temperature, or, in the case of a basic ionogenic group, a pK_{b} of >8 at room temperature.

The emulsifier II may have one or more OH, NH or NH₂ groups or other groups that are reactive towards isocyanates. The number-average molecular weight (Mn, determined by gel permeation chromatography) is preferably <1000 g/mol and very preferably <500 g/mol.

The emulsifier II is preferably at least one sulphonic acid, selected from the group consisting of hydroxyalkylsulphonic acids, hydroxypolyethersulphonic acids, aminoalkylsulphonic acids and aminopolyethersulphonic acids. Preferred hydroxyalkylsulphonic acids are 2-hydroxyethanesulphonic acids and 3-hydroxypropanesulphonic acids. Preferred aminoalkylsulphonic acids are 2-(cyclohexylamino)ethanesulphonic acid and 3-(cyclohexylamino)propanesulphonic acid. Particularly preferred emulsifiers II are sulphonates containing amino groups.

In another embodiment the emulsifier II is at least one phosphate.

The ionogenic group may be generated by neutralization of a free acid, e.g. sulphonic or phosphonic acid derivative. Suitable neutralizing agents for the acid-group-containing ionogenic groups of the emulsifier II are selected from the group consisting of alkali metal hydroxides and alkaline earth metal hydroxides.

The uretdione-containing prepolymer I and the emulsifier II are mixed with or without solvent and then reacted at suitable temperatures. The solvent is preferably selected from the group consisting of water, acetone, dimethylformamide, N-methylpyrrolidone, ethyl acetate, tetrahydrofuran, dioxane. Preferably the solvent is water.

Whereas emulsifiers containing amino groups react exothermically even at room temperature, with emulsifiers containing hydroxy groups it is advisable to establish a reaction temperature between 40-100° C., optionally using catalysts known from the literature, such as dibutyltin dilaurate (DBTL), for example.

The molar ratio of free NCO groups in prepolymer I to NCO-reactive groups in emulsifier II, prior to their reaction, is preferably 2:1 to 1:2, more preferably 1.1:1 to 1:1.1. After the reaction, the free NCO content of the hydrophilic polyisocyanate P is preferably <2 wt %, more preferably <1 wt %.

The hydrophilic polyisocyanate P may be introduced into water by known methods, with or without auxiliary solvent, in order therein to form the aqueous polyurethane-polyurea dispersion A) containing uretdione groups. Dispersion A) is stable for at least 8 weeks, preferably at least 12 weeks, at 50° C., meaning that even after 8 weeks or 12 weeks at 50° C., the reactivity of the hydrophilic polyisocyanate P is comparable with that of the initial mixture.

The aqueous polyurethane-polyurea dispersion A) containing uretdione groups has uretdione groups, which are also referred to as latent NCO groups. For each uretdione group, accordingly, two free NCO groups are generated by ring opening.

The aqueous polyurethane-polyurea dispersion A) containing uretdione groups has a uretdione group content of 0.5 to 25 wt %, based on the total weight of A), preferably 2 to 20 wt % (calculated as C₂N₂O₂, molecular weight 84). The free NCO content is in the range from 0.01 to 1.5 wt %, preferably from 0.05 to 0.3 wt %, based on the total weight of A). Diamines or polyamines B), which are water-soluble, emulsifiable in water or dispersible in water, are known in the literature. They may be monomeric, oligomeric and/or polymeric compounds. Monomeric and oligomeric compounds are preferably selected from the group of diamines, triamines and tetramines. Preference for component B) is given to using primary and/or secondary diamines or polyamines, more preferably primary diamines or polyamines. The amine group of the diamines or polyamines B) may be attached to a primary, secondary or tertiary carbon atom, preferably to a primary or secondary carbon atom.

The following amines in particular may be used as component B):

aliphatic amines, such as the polyalkylene polyamines, diethylenetriamine and triethylenetetramine, trimethylhexamethylenediamine, 2-methylpentanediamine, oxyalkylene polyamines, such as polyoxypropylenediamine and polyoxypropylenetriamine (e.g., Jeffamine® D-230, Jeffamine® D-400, Jeffamine® T-403, Jeffamine® T-5000), 1,13-diamino-4,7,10-trioxatridecane, 2,2,4-trimethylhexamethylenediamine, 2,4,4-trimethylhexamethylenediamine, cycloaliphatic amines, such as isophoronediamine(3,5,5-trimethyl-3-aminomethyl-cyclohexylamine), 4,4′-diaminodicyclohexylmethane, 2,4′-diaminodicyclohexylmethane 2,2′-diaminodicyclohexylmethane, alone or in mixtures of the isomers of H₁₂MDI, 3,3′-dimethyl-4,4′-diamino-dicyclohexylmethane, N-cyclohexyl-1,3-propanediamine, 1,2-diaminocyclohexane, piperazine, N-aminoethylpiperazine, TCD-diamine(3(4), 8(9)-bis(aminomethyl)tricyclo[5.2.1.0²′⁶]decane), araliphatic amines, such as xylylenediamines, aromatic amines, such as phenylenediamines and 4,4′-diaminodiphenylmethane; adduct curing agents, which are the reaction products of epoxide compounds, more particularly glycidyl ethers of bisphenol A and F, with excess amine; polyamidoamine curing agents, which are obtained by condensation of monocarboxylic and polycarboxylic acids with polyamines, more particularly by condensing dimer fatty acids with polyalkylene polyamines;

and Mannich base curing agents, which are obtained by reacting monohydric or polyhydric phenols with aldehydes, more particularly formaldehyde, and polyamines.

Also contemplated are Mannich bases based, for example, on phenol and/or resorcinol, formaldehyde and m-xylylenediamine and also N-aminoethylpiperazine, and blends of N-aminoethylpiperazine with nonylphenol and/or benzyl alcohol. Also suitable, furthermore, are phenalkamines, which are frequently obtained in a Mannich reaction from Cardanols, aldehydes and amines. It is also possible to use mixtures of the aforementioned amine curing agents.

Preference is given to using isophoronediamine(3,5,5-trimethyl-3-aminomethylcyclohexylamine, IPD), 4,4′-diaminodicyclohexylmethane, 2,4′-diaminodicyclohexylmethane 2,2′-diaminodicyclohexylmethane, alone or in mixtures of the isomers (also referred to as PACM), and a mixture of the isomers of 2,2,4-trimethylhexamethylenediamine and 2,4,4-trimethylhexamethylenediamine (TMD). Particular preference is given to using a mixture of the isomers 2,2,4-trimethylhexamethylenediamine and 2,4,4-trimethylhexamethylenediamine. Very particular preference is given to using an approximately 1:1 mixture of the isomers of 2,2,4-trimethylhexamethylenediamine and 2,4,4-trimethylhexamethylenediamine.

Particular preference is given to using diamines and polyamines B) having an octanol-water partition coefficient log P of >0. The P value expresses the ratio of the concentrations of one substance in a two-phase system composed of 1-octanol and water, and is reported in the form of the base-ten logarithm as log P (J. Sangster, Octanol-Water Partition Coefficients: Fundamentals and Physical Chemistry, Vol. 2 of Wiley Series in Solution Chemistry, John Wiley & Sons, Chichester, 1997). The octanol-water partition coefficient goes up with increasing fat-solubility and decreasing water-solubility. Particular preference is given to using diamines and polyamines B) having an octanol-water partition coefficient log P of >0, calculated after input of the structural formula of the respective compound using the program Chem Draw Pro 12.0.2.1076, (©1986-2010 CambridgeSoft.). Particularly preferred are diamines and polyamines B) having an octanol-water partition coefficient log P of >0.5, very preferably with a log P of >1.0. For example, the preferred diamines isophoronediamine(3,5,5-trimethyl-3-aminomethylcyclohexylamine, IPD), 4,4′-diaminodicyclohexylmethane, 2,4′-diaminodicyclohexylmethane, 2,2′-diaminodicyclohexylmethane, alone or in mixtures of the isomers, and a mixture of the isomers of 2,2,4-trimethylhexamethylenediamine and 2,4,4-trimethylhexamethylenediamine (TMD) have an octanol-water partition coefficient log P of >1.

The ratio of latent NCO groups in the polyurethane-polyurea dispersion A) containing uretdione groups to the amine groups in component B) in accordance with the invention is preferably 4:1 to 1:1, more preferably 2.2:1 to 2:1.2.

As optional component C) it is possible to add the customary adjuvants, such as flow control agents, e.g. polysilicones or acrylates, light stabilizers, e.g. sterically hindered amines, or other auxiliaries, as described in, for example, EP 0 669 353, examples being stabilizers, degassing agents, emulsifying assistants and dispersing additives, in a total amount of 0.05 to 5 wt %, based on the total weight of the composition. Fillers and pigments such as titanium dioxide, for example, can be added in an amount of up to 50 wt % of the total composition. Preference is given to auxiliaries and additives that are customary within the coatings sector, such as flow control assistants, colour pigments, fillers, matting agents and external emulsifiers, for example.

Organic solvents are suitable as auxiliary C). Liquid substances which do not react with other ingredients may be added to the aqueous composition of the invention, examples being ethyl acetate, butyl acetate, ethylene glycol monomethyl ether acetate, ethylene glycol monoethyl ether acetate, 1-methoxyprop-2-yl acetate, 3-methoxy-n-butyl acetate, acetone, 2-butanone, 4-methyl-2-pentanone, cyclohexanone, toluene, xylene, chlorobenzene, white spirit, aromatics with relatively high levels of substitution, of the kind available commercially, for example, under the designations Solvent naphtha, Solvesso®, Isopar®, Nappar® (Deutsche EXXON CHEMICAL GmbH) and Shellsol® (Deutsche Shell Chemie GmbH), carbonic esters, such as dimethyl carbonate, diethyl carbonate, 1,2-ethylene carbonate and 1,2-propylene carbonate, lactones, such as propiolactone, butyrolactone, caprolactone and methylcaprolactone, and also solvents such as propylene glycol diacetate, diethylene glycol dimethyl ether, dipropylene glycol dimethyl ether, diethylene glycol ethyl ether acetate, diethylene glycol butyl ether acetate, N-methylpyrrolidone and N-methylcaprolactam, or any other desired mixtures of such solvents.

These solvents are preferably used merely as auxiliary solvents and account for only relatively small fractions by comparison with the principal solvent water. The volume ratio of water to auxiliary solvent is preferably greater than 2:1 and with preference is in the range from 100:1 to 10:1.

For producing the reactive composition of the invention, components A) and B) are mixed and optionally admixed with further auxiliary and adjuvant components C).

Customary catalysts known from polyurethane chemistry may also be used, examples being tertiary amines such as triethylamine, pyridine, methylpyridine, benzyldimethylamine, N,N-endoethylenepiperazine, N-methylpiperidine, pentamethyldiethylenetriamine, N,N-dimethylaminocyclohexane, N,N′-dimethylpiperazine or metal salts such as iron(II) chloride, aluminium tri(ethyl acetoacetate), zinc chloride, zinc(II) n-octanoate, zinc(II) 2-ethyl-1-hexanoate, zinc(II) 2-ethylcaproate, zinc(II) stearate, zinc(II) naphthenate, zinc(II) acetylacetonate, tin(II) n-octanoate, tin(II) 2-ethyl-1-hexanoate, tin(II) ethylcaproate, tin(II) laurate, tin(II) palmitate, dibutyltin(IV) oxide, dibutyltin(IV) dichloride, dibutyltin(IV) diacetate, dibutyltin(IV) dimaleate, dibutyltin(IV) dilaurate, dioctyltin(IV) diacetate, molybdenum glycolate, or any desired mixtures of such catalysts.

The catalysts can be used in the method of the invention with a concentration in the range from 0.001 to 2 wt %, preferably in the range from 0.005 to 0.5 wt %, based on the total weight of the reactants A) and B).

A further subject of the invention is the use of the reactive composition of the invention as a starting component in the production of polyurethane plastics, for water-soluble or dispersible film-forming binders or film-forming binder components in the production of coatings using aqueous coating materials based on such binders or binding components.

Also a subject of the invention, therefore, are coatings, adhesive bonds and sealants produced using the reactive composition of the invention comprising at least one aqueous polyurethane-polyurea dispersion, containing uretdione groups, with internal emulsifiers and diamines or polyamines. The coatings, adhesive bonds and sealants of the invention are preferably produced using a reactive composition of the invention.

The method for producing a coating, an adhesive bond or a sealant comprises applying the reactive composition comprising at least one aqueous polyurethane-polyurea dispersion, containing uretdione groups, with specific internal emulsifiers and diamines or polyamines to a substrate. The reactive composition applied may comprise further components such as those specified above.

The applied composition is cured and dried preferably at temperatures between 15° C. and 100° C. in a time between 30 seconds and one week. With particular preference the curing and drying are carried out at 20-50° C. in a time of 5 minutes to 24 hours. Very preferably the curing and drying are carried out at 20-30° C. in a time of 30 minutes to 24 hours.

Suitable substrates to which the composition of the invention is applied are any desired substrates, examples being metal, wood, glass, stone, ceramic materials, concrete, rigid and flexible plastics, textiles, leather and paper, which before such application, may optionally also be provided with customary primers.

In addition to the preferred use as a reactive composition for aqueous 2K PU paints, the reactive compositions of the invention are outstandingly suitable for aqueous dispersion-based adhesives, leather coatings and textile coatings or textile printing pastes, as paper auxiliaries which are free from organically bonded halogens (AOX-free), or else as additives for mineral building materials, examples being concrete compositions or mortar compositions.

The reactive compositions of the invention and a method for producing them will be described by way of example below, without any intention that the invention should be confined to these exemplary embodiments.

References below to ranges, general formulae or classes of compound should be taken to encompass not only the corresponding ranges or groups of compounds that are explicitly mentioned, but also all sub-ranges and sub-groups of compounds that may be obtained by extracting individual values (ranges) or compounds. Where documents are cited in the context of the present description, it is intended that their content fully form part of the disclosure content of the present invention.

Having generally described this invention, a further understanding can be obtained by reference to certain specific examples which are provided herein for purposes of illustration only, and are not intended to be limiting unless otherwise specified.

### Examples

### Example a

### Preparation of Dispersion a Containing Uretdione Groups

### Non-Inventive

a1) Preparation of a Prepolymer I Containing Uretdione Groups from IPDI

IPDI-based uretdione was prepared according to the protocol from DE 10 2005 036654. 10 000 g (45.0 mol) of isophorone diisocyanate (Vestanat® IPDI, Evonik) were admixed at room temperature under dry nitrogen and with stirring with 200 g (2%) of 4-dimethylaminopyridine (DMAP) as catalyst. After 24 hours, the reaction mixture, which had an NCO content of 27.2%, corresponding to a degree of oligomerization of 26.5%, was freed from volatile constituents without prior addition of a catalyst poison, using a thin-film evaporator, at a temperature of 160° C. and a pressure of 0.3 mbar. This gave a highly viscous, pale yellow uretdione polyisocyanate having a free NCO group content of 16.8% and a monomeric IPDI content of 0.3%. No isocyanurate structures were found in the ¹³C NMR spectrum.

a2) Preparation of the Dispersion A) Containing Uretdione Groups According to WO/2014/053269

1050.6 g of IPDI uretdione (from preparation protocol a1) was dissolved with 95.5 g of trimethylolpropane (Aldrich) and 0.23 g of DBTL (dibutyltin dilaurate, Aldrich) in 1.4 l of acetone. After an hour of stirring under reflux (free NCO content: 3.64%), an addition of 103 g of butanol was made, followed by a further 1.5 hours of heating under reflux, under which the free NCO content was 1.49%. Cooling was followed by the dropwise addition of 151 g of Vestamin® A95 (sodium hydroxide-neutralized, amine-containing alkylsulphonate, 50% in water, Evonik) as internal emulsifier. After the end of the addition, heating at reflux took place again for 1.5 hours, after which the product was cooled. The free NCO content was 0.1%, the free amine number 0.2%.

650 g of this product were admixed with 604 g of DI water with vigorous stirring on a Dispermat (3000 rpm). The acetone was removed on a rotary evaporator at 60° C. and 40 mbar, after which the product was filtered using a 50 μm filter. The latent NCO content was 4.5%, the solids content about 27% and the viscosity 163 mPas.

### Example b

### Composition Comprising Dispersion A) Containing Uretdione Groups and Jeffamine® D-400

### Inventive

At room temperature, 200 g of the dispersion A) containing uretdione groups from example a) were admixed with the amount of Jeffamine® D-400 indicated in table 1, with stirring. After 24 hours of stirring at room temperature, a determined was made of the latent NCO content, and from that the stated conversion of the uretdione group, in percent, was ascertained.

### Example c

### Composition Comprising Dispersion A) Containing Uretdione Groups and Propylenediamine

### Inventive

At room temperature, 200 g of the dispersion A) containing uretdione groups from example a) were admixed with the amount of propylenediamine indicated in table 1, with stirring. After 24 hours of stirring at room temperature, a determined was made of the latent NCO content, and from that the stated conversion of the uretdione group, in percent, was ascertained.

### Examples d-f

### Composition Comprising Dispersion A) Containing Uretdione Groups and Vestamin® Grades

### Inventive

At room temperature, 200 g of the dispersion A) containing uretdione groups from example a) were admixed with the amount of the respective Vestamin® grade reported in table 1, with stirring. After 24 hours of stirring at room temperature, a determined was made of the latent NCO content, and from that the stated conversion of the uretdione group, in percent, was ascertained.

### Example g

### Storage of the Dispersion A) Containing Uretdione Groups without Amine Component

### Comparative Example

At room temperature, 200 g of the dispersion A) containing uretdione groups from example a) were stirred for 24 hours, after which the latent NCO content was determined, and, from that, the reported conversion of the uretdione group was ascertained.

TABLE 1

| | | | Initial mass | Uretdione | log P |
|---|---|---|---|---|---|
| | | | (g) of | conversion | (cal.)* |
| | Initial mass | | uretdione | after 24 h | of the |
| Example | (g) | Amine | component A) | (%) | amine |
| b | 23.71 | Jeffamin D400 | 200 | 14 | −0.26 |
| c | 3.80 | Propylene-diamine | 200 | 10 | −1.23 |
| d | 8.57 | Vestamin TMD | 200 | 66 | 1.04 |
| e | 9.10 | Vestamin IPD | 200 | 26 | 1.05 |
| f | 11.25 | Vestamin PACM | 200 | 21 | 1.53 |
| g (comparative) | 0.00 | Amine | 200 | <1 | |

*Calculation via the ChemDraw Pro 12.0.2.1076 program ( ©1986-2010 CambridgeSoft.) through input of the structural formula of each individual compound

Vestamin® TMD: Approximately 1:1 mixture of 2,2,4-trimethylhexamethylenediamine and 2,4,4-trimethylhexamethylenediamine

Vestamin® IPD: Isophoronediamine

Vestamin® PACM: Bis-para-aminocyclohexylmethane(4,4′-diaminodicyclohexylmethane)Vestamin® from Evonik AG

Jeffamine® D-400: Polyoxypropylenediamine with molecular weight of 430 g/mol on average, Huntsman

From Table 1 it is apparent that the inventive compositions b-f all exhibit significant uretdione conversions after 24 hours at room temperature. The inventive compositions d-f show significantly higher uretdione conversions than examples b and c, for which amines with a negative partition coefficient log P were used. The highest conversion is achieved in example d, with Vestamin® TMD. Comparative example g shows that the component containing uretdione groups from example a is stable in the absence of amines.

German patent application 102014209183.7 filed May 15, 2014, is incorporated herein by reference.

Numerous modifications and variations on the present invention are possible in light of the above teachings. It is therefore to be understood that within the scope of the appended claims, the invention may be practiced otherwise than as specifically described herein.

1. A reactive composition, comprising:
A) an aqueous polyurethane-polyurea dispersion containing an uretdione group and comprising an internal emulsifier, the emulsifier comprising at least one ionogenic group which, in the case of an acidic ionogenic group, has a pKₐ in water of >8 at room temperature or, in the case of a basic ionogenic group, has a pK_{b} of >8 at room temperature,
B) at least one diamine, polyamine or a mixture thereof,
wherein a ratio of a latent NCO group in the polyurethane-polyurea dispersion A) containing an uretdione group to the amine groups in component B) is from 4:1 to 1:1, and
C) optionally, at least one member selected from the group consisting of an auxiliary, an adjuvant and a catalyst.

2. The reactive composition according to claim 1, wherein A) is obtained by
converting a polyisocyanate carrying an uretdione group into prepolymer I containing an uretdione group,
reacting of the free NCO groups with a monomeric, oligomeric and/or polymeric compound containing a hydroxyl group,
subsequently, converting of the prepolymer I carrying uretdione groups, with at least one emulsifier II, into a hydrophilic polyisocyanate P, and
subsequently, dispersing of the hydrophilic polyisocyanate P in water.

3. The reactive composition according to claim 1, wherein use is made of a polyisocyanate carrying an uretdione group that is based on a diisocyanate selected from the group consisting of isophorone diisocyanate, hexamethylene diisocyanate, 2,2′-dicyclohexylmethane diisocyanate, 2,4′-dicyclohexylmethane diisocyanate, 4,4′-dicyclohexylmethane diisocyanate, mixtures of isomers of H₁₂MDI, 2-methylpentane diisocyanate, a mixture of 2,2,4-trimethylhexamethylene diisocyanate and 2,4,4-trimethylhexamethylene diisocyanate, norbornane diisocyanate, methylenediphenyl diisocyanate, toluidine diisocyanate, tetramethylxylylene diisocyanate, m-xylylene diisocyanate, and mixtures thereof.

4. The reactive composition according to claim 1, wherein use is made of a compound containing a hydroxyl group that is selected from the group consisting of polyesters, polythioethers, polyethers, polycaprolactams, polyepoxides, polyesteramides, polyurethanes, low molecular mass dialcohols, low molecular mass trialcohols, low molecular mass tetraalcohols, monoalcohols, and mixtures thereof.

5. The reactive composition according to claim 2, wherein prepolymer I containing an uretdione group has a free NCO content of at least 0.2 to 20 wt %, based on the total weight of the prepolymer, and an uretdione group content of 0.5 to 25 wt %, based on the total weight of the prepolymer.

6. The reactive composition according to claim 2, wherein the emulsifier II has one or more OH, NH or NH₂ groups.

7. The reactive composition according to claim 2, wherein the emulsifier II is a sulphonic acid.

8. The reactive composition according to claim 2, wherein the emulsifier II is selected from the group consisting of hydroxyalkylsulphonic acids, hydroxypolyethersulphonic acids, aminoalkylsulphonic acids and aminopolyethersulphonic acids, and mixtures thereof.

9. The reactive composition according to claim 2, wherein the emulsifier II is selected from the group consisting of 2-hydroxyethanesulphonic acids, 3-hydroxypropanesulphonic acids, 2-(cyclohexylamino)ethanesulphonic acid, 3-(cyclohexylamino)propanesulphonic acid, and mixtures thereof.

10. The reactive composition according to claim 1, wherein the aqueous polyurethane-polyurea dispersion A) containing an aqueous uretdione group has a uretdione group content of 0.5 to 25 wt %, based on the total weight of A), calculated as C₂N₂O₂, molecular weight 84, and the free NCO content is in the range from 0.01 to 1.5 wt %, based on the total weight of A).

11. The reactive composition according to claim 1, wherein component B) is selected from the group consisting of primary diamines, secondary diamines, polyamines and mixtures thereof.

12. The reactive composition according to claim 1, wherein component B) is an amine selected from the group consisting of polyalkylenepolyamines, diethylenetriamine, triethylenetetramine, trimethylhexamethylenediamine, 2-methylpentanediamine, oxyalkylenepolyamines, polyoxypropylenediamine, polyoxypropylenetriamine, 1,13-diamino-4,7,10-trioxatridecane, 2,2,4-trimethylhexamethylenediamine, 2,4,4-trimethylhexamethylenediamine, cycloaliphatic amines, isophoronediamine(3,5,5-trimethyl-3-aminomethyl-cyclohexylamine), 4,4′-diaminodicyclohexylmethane, 2,4′-diaminodicyclohexylmethane 2,2′-diaminodicyclohexylmethane, mixtures of diaminodicyclohexylmethane isomers, 3,3′-dimethyl-4,4′-diaminodicyclohexylmethane, N-cyclohexyl-1,3-propanediamine, 1,2-diaminocyclohexane, piperazine, N-aminoethylpiperazine, TCD-diamine(3(4), 8(9)-bis(aminomethyl)tricyclo[5.2.1.0^{2,6}]decane), araliphatic amines, xylylenediamines, aromatic amines, phenylenediamines, 4,4′-diaminodiphenylmethane, and mixtures thereof.

13. The reactive composition according to claim 1, wherein component B) is an amine selected from the group consisting of adduct curing agents which are the reaction products of epoxide compounds with excess amine;
polyamidoamine curing agents which are obtained by condensing monocarboxylic and polycarboxylic acids with polyamines;
and Mannich base curing agents, which are obtained by reacting mono- or polyhydric phenols with aldehydes;
Mannich bases based on phenol and/or resorcinol, formaldehyde and m-xylylenediamine, and also N-aminoethylpiperazine and blends of N-aminoethylpiperazine with nonylphenol and/or benzyl alcohol; phenalkamines, and mixtures thereof.

14. The reactive composition according to claim 1, wherein component B) has an octanol-water partition coefficient log P of >0.

15. The reactive composition according to claim 1, wherein component B is a polyamine having an octanol-water partition coefficient with log P of >1.0, selected from the group consisting of isophoronediamine, 4,4′-diaminodicyclohexylmethane, 2,4′-diaminodicyclohexylmethane, 2,2′-diaminodicyclohexylmethane, mixtures of diaminodicyclohexylmethane isomers, a mixture of the isomers of 2,2,4-trimethylhexamethylenediamine and 2,4,4-trimethylhexamethylenediamine, and mixtures thereof.

16. The reactive composition according to claim 1, wherein component C) is selected from the group consisting of flow control agents, light stabilizers, other stabilizers, degassing agents, emulsifying assistants, dispersing additives, fillers, pigments, and mixtures thereof.

17. The reactive composition according to claim 1, wherein component C) is selected from the group consisting of solvents and mixtures thereof.

18. The reactive composition according to claim 1, wherein component C) is a catalyst selected from the group consisting of tertiary amines, triethylamine, pyridine, methylpyridine, benzyldimethylamine, N,N-endoethylenepiperazine, N-methylpiperidine, pentamethyldiethylenetriamine, N,N-dimethylaminocyclohexane, N,N′-dimethylpiperazine, metal salts, iron(II) chloride, aluminium tri(ethyl acetoacetate), zinc chloride, zinc(II) n-octanoate, zinc(II) 2-ethyl-1-hexanoate, zinc(II) 2-ethylcaproate, zinc(II) stearate, zinc(II) naphthenate, zinc(II) acetylacetonate, tin(II) n-octanoate, tin(II) 2-ethyl-1-hexanoate, tin(II) ethylcaproate, tin(II) laurate, tin(II) palmitate, dibutyltin(IV) oxide, dibutyltin(IV) dichloride, dibutyltin(IV) diacetate, dibutyltin(IV) dimaleate, dibutyltin(IV) dilaurate, dioctyltin(IV) diacetate, molybdenum glycolate, and mixtures thereof.

19. The reactive composition according to claim 1, wherein component C) is present.

20. A method for producing the reactive composition according to claim 1, comprising: mixing the components A) and B) and optionally component C).
